(19) United States
(12) Patent Application Publication
(10) Pub. No.: US 2011/0007845 A1
(43) Pub. Date: Jan. 13, 2011

(54) COMMUNICATION RECEIVER HAVING THREE FILTERS CONNECTED IN SERIES

(76) Inventors: Yen-Horng Chen, Taipei City (TW); Sheng-Jui Huang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/499,081

(22) Filed: Jul. 7, 2009

(51) Int. Cl. H04L 25/06; H04L 27/06; H04L 27/22

(52) U.S. Cl. 375/319; 375/344; 375/322

(57) ABSTRACT

A communication receiver includes a mixer, a filter group and an analog-to-digital converter. The mixer is used for mixing an input signal with a local oscillation signal to generate a mixed signal. The filter group is coupled to the mixer, and is used for filtering the mixed signal to generate a filtered signal, where the filter group includes a first one-pole filter, a second one-pole filter, and a complex-pole filter. The analog-to-digital converter is coupled to the filter group, and is used for performing an analog-to-digital converting operation on the filtered signal to generate a digital signal.

### BACKGROUND

The present invention relates to a communication receiver, and more particularly, to a communication receiver having three filters connected in series.

In a receiver of a communication system, filters are provided to filter an in-phase signal (I signal) and a quadrature signal (Q signal), and the filtered I and Q signals are respectively inputted into analog-to-digital converters (ADC) to generate digitized I and Q signals. To prevent a saturation of the filtered I and Q signals (i.e., the filtered I and Q signals are over a full scale of the ADC) and save ADC bits, the filters need to be designed to lower an idle tone and have large adjacent channel rejection. In addition, sizes of the filters (chip area) also need to be decreased to save the manufacture cost.

### SUMMARY

According to one embodiment of the present invention, a communication receiver comprises a mixer, a filter group and an analog-to-digital converter. The mixer is used for mixing an input signal with a local oscillation signal to generate a mixed signal. The filter group is coupled to the mixer, and is used for filtering the mixed signal to generate a filtered signal, where the filter group comprises a first one-pole filter, a second one-pole filter, and a complex-pole filter. The analog-to-digital converter is coupled to the filter group, and is used for performing an analog-to-digital converting operation on the filtered signal to generate a digital signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication receiver 100 according to one embodiment of the present invention.

FIG. 2 is a diagram illustrating simulation results of several filters.

FIG. 3 is an exemplary circuit diagram of a one-pole filter 300.

FIG. 4 is an exemplary circuit diagram of a two-pole filter 400.

FIG. 5 is another exemplary circuit diagram of a two-pole filter 500.

FIG. 6 is a diagram illustrating a filter group according to the filter at row 4 shown in FIG. 2.

FIG. 7 is a circuit diagram illustrating the filter group according to one embodiment of the present invention

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

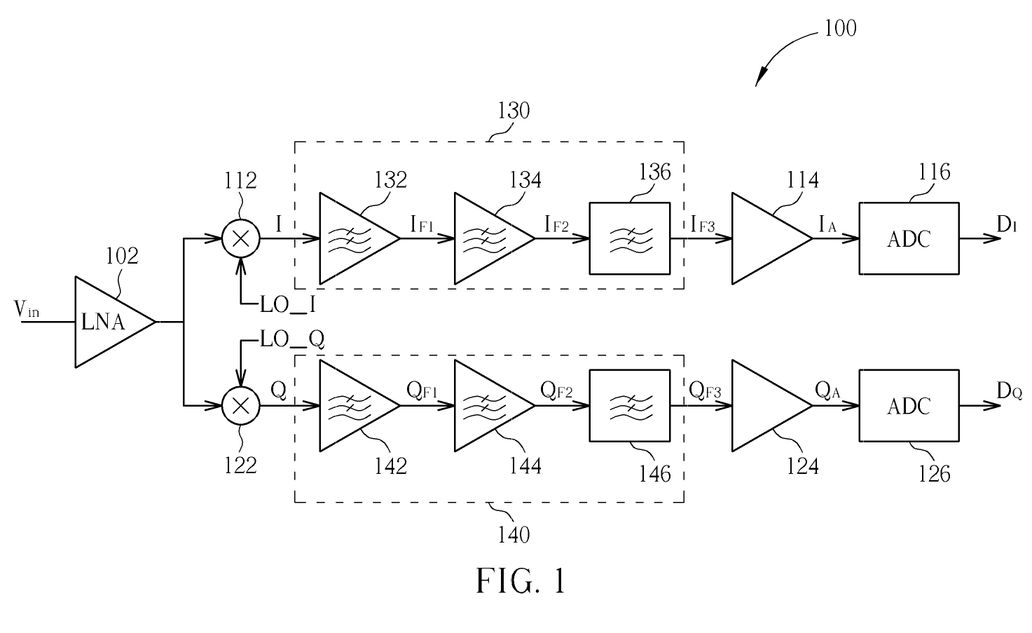

FIG. 1 is a diagram illustrating a communication receiver 100 according to one embodiment of the present invention. The communication receiver 100 includes a low-noise amplifier (LNA) 102, two mixers 112 and 122, two filter groups 130 and 140, two amplifiers 114 and 124, and two analog-to-digital converters (ADCs) 116 and 126, where the filter group 130 includes a first filter 132, a second filter 134 and a third filter 136, and the filter group 140 includes a fourth filter 142, a fifth filter 144 and a sixth filter 146. The first, second, fourth and fifth filters 132, 134, 142, 144 are one-pole filters, and the third and sixth filters 136 and 146 are complex-pole filters. In addition, the mixer 112, the filter group 130, the amplifier 114 and the ADC 116 serve as an I-channel, and the mixer 122, the filter group 140, the amplifier 124 and the ADC 126 serve as a Q-channel.

In addition, the first, second, fourth and fifth filters 132, 134, 142 and 144 are one-pole filters, and more particularly, the first, second, fourth and fifth filters 132, 134, 142 and 144 are real-pole filters, where the real-pole filter has a pole located at a real-axis of a well-known s-plane.

In addition, in this embodiment, the third and sixth filters 136 and 146 are two-pole filters, and pole quality factors of the third and sixth filters 136 and 146 are both greater than one. The pole quality factor is defined as follows: a general second-order filter transfer function can be expressed in a standard form:

$$T ( s ) = \frac{{a}_{2} s + {a}_{1} s + {a}_{0}}{{s}^{2} + ( \frac{{ω}_{0}}{Q} ) s + {ω}_{0}^{2}}$$

where a₁, a₂, a₃ are coefficients, ω₀ is nature frequency, and Q is the pole quality factor.

In the operations of the communication receiver 100, the LNA 102 receives and amplifies an input signal Vᵢₙ to generate an amplified input signal, and the amplified input signal is inputted into the mixers 112 and 122. Then, in the I-channel, the mixer 112 mixes the amplified input signal with a first local oscillation signal LO_I to generate an in-phase signal (I signal), and the first filter 132 filters the I signal to generate a filtered I signal I_{F1}, the second filter 134 filters the filtered I signal I_{F1} to generate a filtered I signal I_{F2}, and the third filter 136 filters the filtered I signal I_{F2} to generate a filtered I signal I_{F3}. Then, the amplifier 114 amplifies the filtered I signal I_{F3} to generate an amplified I signal I_{AI}. Finally, the ADC 116 executes an analog-to-digital conversion operation upon the amplified I signal I_{A} to generate a digitized I signal D_{I}. Similarly, in the Q-channel, the mixer 122 mixes the amplified input signal with a second local oscillation signal LO_Q to generate a quadrature signal (Q signal), and the fourth filter 142 filters the Q signal to generate a filtered Q signal Q_{F1}, the second filter 144 filters the filtered Q signal Q_{F1} to generate a filtered Q signal Q_{F2}, and the third filter 146 filters the filtered Q signal Q_{F2} to generate a filtered Q signal Q_{F3}. Then, the amplifier 124 amplifies the filtered Q signal Q_{F3} to generate an amplified Q signal Q_{A}. Finally, the ADC 126 executes an analog-to-digital conversion operation upon the amplified Q signal Q_{A} to generate a digitized Q signal D_{Q}.

It is noted that the amplifiers 114 and 124 are optional devices. In another embodiment, the amplifiers 114 and 124 can be removed from the communication receiver 100, where the ADC 116 directly executes an analog-to-digital conversion operation upon the filtered I signal I_{F3} to generate a digitized I signal D_{I}, and the ADC 126 directly executes an analog-to-digital conversion operation upon the filtered Q signal Q_{F3} to generate a digitized Q signal D_{Q}.

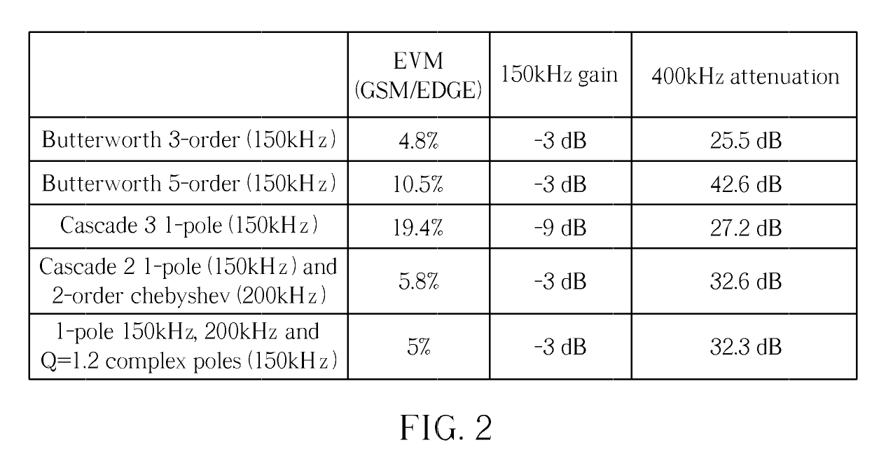

FIG. 2 is a diagram illustrating simulation results of several filters. In FIG. 2, there are five filters. The first three filters are conventional filters (a Butterworth 3-order filter; a Butterworth 5-order filter; three 1-pole filters cascaded in series), and the last two filters are the filter groups of embodiments of the present invention. There are also three simulations: error vector magnitude (EVM) (in GSM/EDGE system), filter gain at 150 kHz, and attenuation at 400 kHz. The simulations shown in FIG. 2 are based on a 200 kHz bandwidth of a channel, therefore the attenuation at 400 kHz is an index for adjacent channel rejection. The greater the attenuation at 400 kHz, the better the adjacent channel rejection. Referring to FIG. 2, the filters of the embodiments (e.g., the last two filters) have small EVM and less filter loss at 150 kHz, and great attenuation at 400 kHz. Therefore, the filters of the present invention have larger adjacent channel rejection that can save one ADC bit, and have smaller in-band loss and group delay variation which can reduce digital compensation effort.

In addition, regarding a chip area of the filter of the present invention, the filter group 130 or 140 of the present invention has a chip area of approximately “0.1107 mm²” (in a 65 nm process). Compared with other conventional filter groups such as a one-pole filter and Butterworth 3-order filter connected in series with a chip area of “0.1269 mm²” (in a 65 nm process), the filter group of the present invention has a smaller chip area.

In addition, referring to the filter of one embodiment of the present invention at row 5 shown in FIG. 2, the two 1-pole filters respectively having corner frequencies (i.e., cutoff frequencies) 150 kHz and 200 kHz can be served as the first filter 132 and the second filter 134 shown in FIG. 1 (or the fourth filter 142 and the fifth 144 shown in FIG. 1), respectively, and the complex pole filter with Q=1.2 can be served as the third filter 136 (or the sixth filter 146). It can be seen that the corner frequency of the first filter 132 can be different from the corner frequency of the second filter 134. On the other hand, referring to the filter of another embodiment of the present invention at row 4 shown in FIG. 2, the cascade two one-pole filters both having the corner frequency 150 kHz can be served as the first filter 132 and the second filter 134 shown in FIG. 1 (or the fourth filter 142 and the fifth 144 shown in FIG. 1), respectively, and the 2^{nd}-order Chebyshev filter can be served as the third filter 136 (or the sixth filter 146). That is, the corner frequency of the first filter 132 can be the same as the corner frequency of the second filter 134.

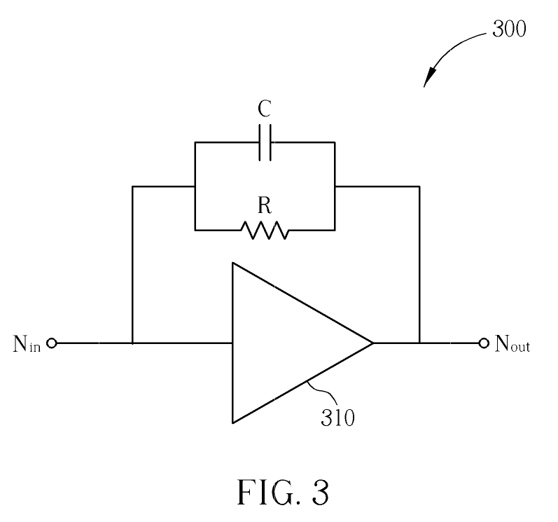

FIG. 3 is an exemplary circuit diagram of a one-pole filter 300. The one-pole filter 300 includes an operational amplifier 310, a resistor R and a capacitor C, where Nᵢₙ is an input signal terminal and Nₒᵤₜ is an output signal terminal. In addition, the first, second, fourth and fifth filters 132, 134, 142, 144 can be implemented by the one-pole filter 300.

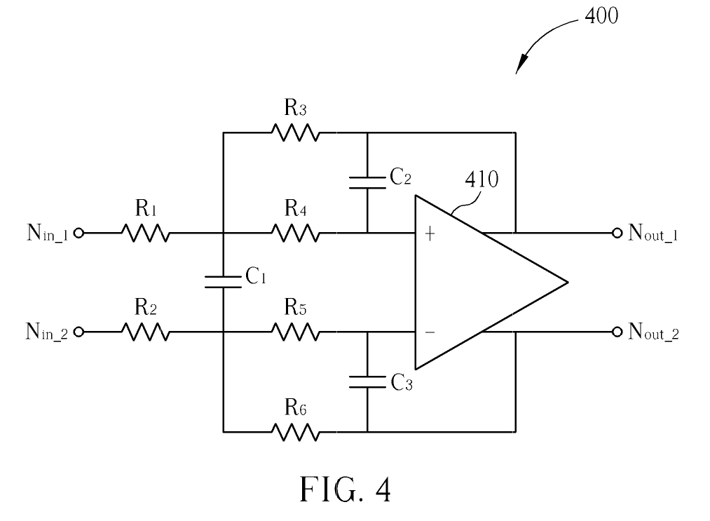

FIG. 4 is an exemplary circuit diagram of a two-pole filter 400. The two-pole filter 400 includes an operational amplifier 410, six resistors R₁-R₆ and three capacitors C₁-C₃, where Nᵢₙ_{_{—}}₁ and Nᵢₙ_{_{—}}₂ serve as input signal terminals, and Nₒᵤₜ_{_{—}}₁ and Nₒᵤₜ_{_{—}}₂ serve as output signal terminals. In addition, the third and sixth filters 136 and 146 can be implemented by the two-pole filter 400.

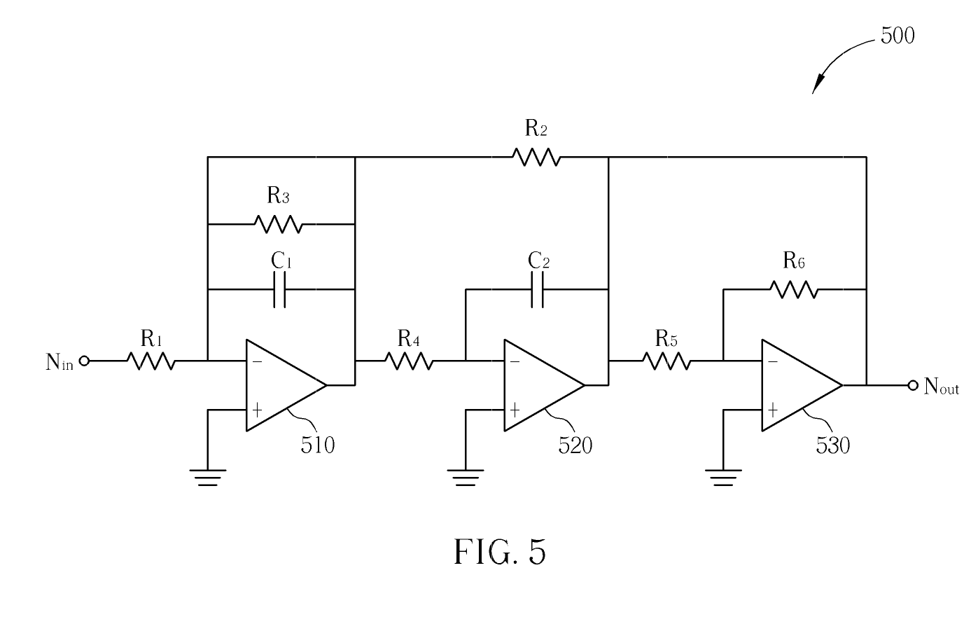

FIG. 5 is another exemplary circuit diagram of a two-pole filter 500. The two-pole filter 500, which is a well-known Tow-Thomas biquad filter, includes three operational amplifiers 510, 520 and 530, six resistors R₁-R₆, and two capacitors C₁ and C₂, where Nᵢₙ is an input signal terminal and Nₒᵤₜ is an output signal terminal. In addition, in the two-pole filter 500, the pole quality factor Q is equal to:

$$\sqrt{\frac{{R}_{3}^{2} {C}_{1}}{{R}_{2} {R}_{4} {C}_{2}}} .$$

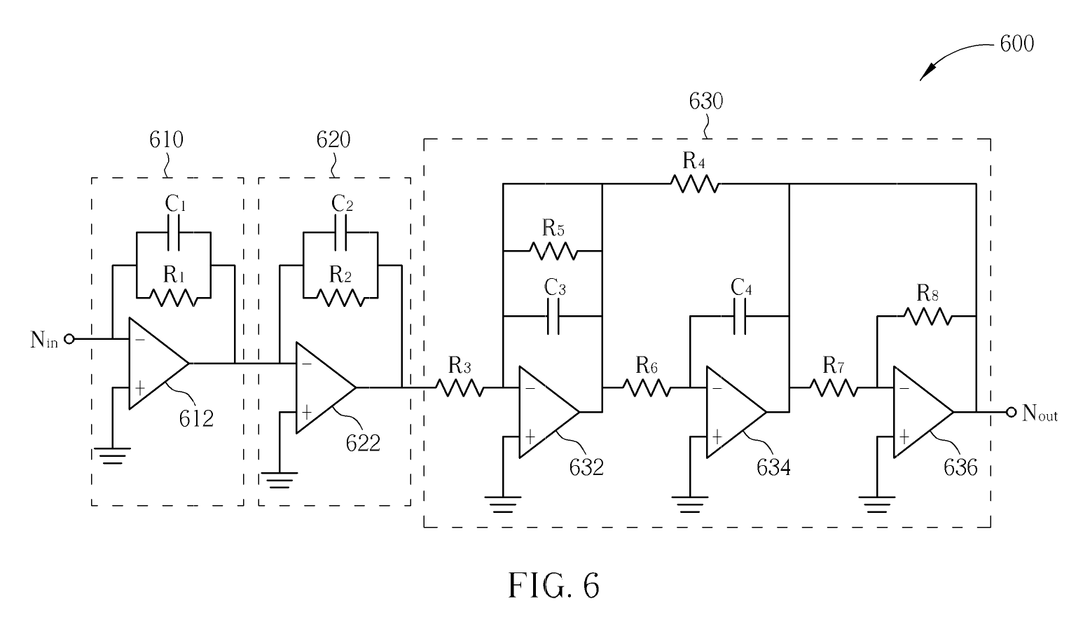

In addition, FIG. 6 is a diagram illustrating a filter group 600 according to the filter at row 4 shown in FIG. 2. As shown in FIG. 6, the filter group 600 includes a first filter 610, a second filter 620 and a third filter 630. The first filter 610 is a one-pole filter, and includes an operational amplifier 612, a resistor R₁ and a capacitor C₁. The second filter 620 is also a one-pole filter, and includes an operational amplifier 622, a resistor R₂ and a capacitor C₂. The third filter 630 is a second-order Chebyshev filter with Tow-Thomas implementation, and includes three operational amplifiers 632, 634 and 636, six resistors R₃-R₈ and two capacitors C₃ and C₄.

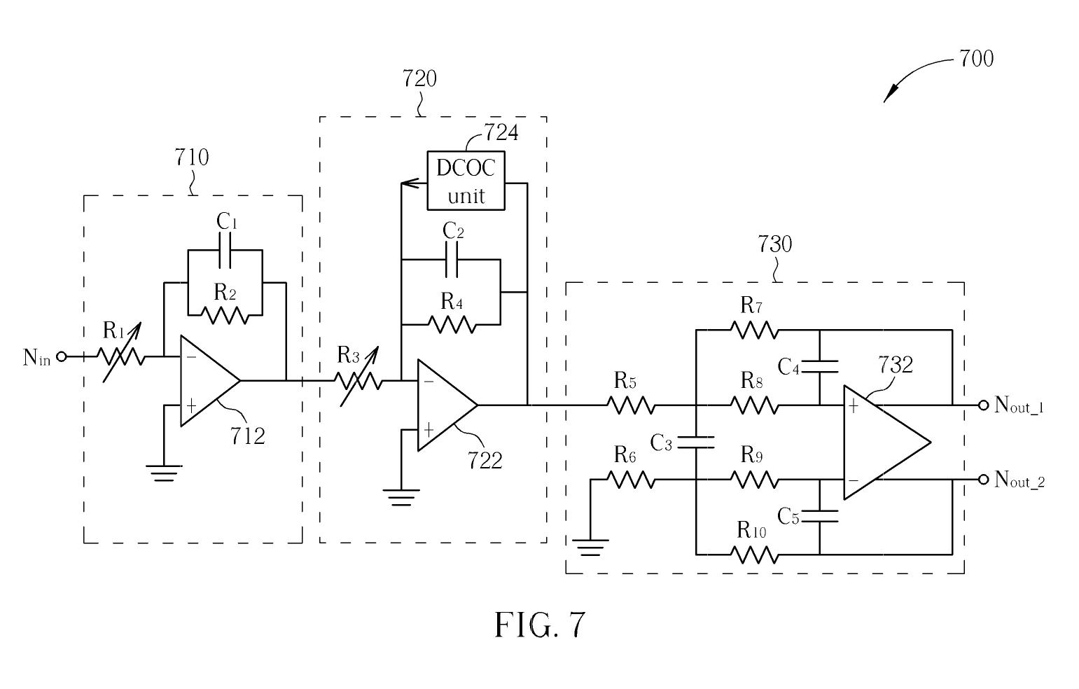

FIG. 7 is a circuit diagram illustrating the filter group 700 according to one embodiment of the present invention, where the filter group 700 can be served as the filter group 130 or 140 shown in FIG. 1. The filter group 700 includes a first filter 710, a second filter 720 and a third filter 730. The first filter 710 includes an operational amplifier 712, a variable resistor R₁, a resistor R₂ and a capacitor C₁. The second filter 720 includes an operational amplifier 722, a variable resistor R₃, a resistor R₄, a capacitor C₂ and a DC offset cancellation unit (DCOC unit) 724. In other words, the first and second filters 710 and 720 are RC active filters. The third filter 730 includes an operational amplifier 732, six resistors R₅-R₁₀ and three capacitors C₃-C₅.

Generally, the DCOC unit is required to be used in all the conventional filter(s) of the communication receiver to prevent an accumulation of the DC offsets. However, although the DCOC unit can cancel the DC offset, the DCOC unit requires many switching operations and will generate much noise. Referring to the filter group shown in FIG. 7, the DCOC unit is not built in the first filter 710 (the DCOC unit 724 is only built in the second filter 720), therefore, the output signal of the first filter 710 has less noise.

Furthermore, because the first filter 710 and second filter 720 are both the one-pole filters, therefore, the noise generated from the first filter 710 and second filter 720 are much less than that generated from the conventional 3^{rd}-order or 5^{th}-order Butterworth filter. That is, the output signal of the second filter 720 has less noise than that of the conventional filter of the communication receiver.

In addition, because the first filter 710 usually is used to provide high gain, therefore, the noise from the second filter 720 can be suppressed by the gain of the first filter 710. Therefore, in the design of a resistance of the resistor R₄ and a capacitance of the capacitor C₂, the resistance of the resistor R₄ can be designed larger and the capacitance of the capacitor C₂ can be designed smaller (a product R₄*C₂ is relative to the corner frequency of the filter, and should be a constant), and the chip area of the second filter 720 can be decreased to save the manufacture cost (the capacitor needs a greater chip area than the resistor).

Briefly summarized, the filter group of the present invention includes two one-pole filters and a complex-pole filter cascaded in series. The filter group has a larger adjacent channel rejection that may save one ADC bit, and has smaller in-band loss and group delay variation which can reduce digital compensation effort. In addition, the filter group of the present invention has a smaller chip area than conventional filter groups.

Those skilled in the art will readily observe that numerous modifications and alterations of the device and method may be made while retaining the teachings of the invention.

What is claimed is:

1. A communication receiver, comprising:
a first mixer, for mixing an input signal with a first local oscillation signal to generate a first mixed signal;
a first filter group, for filtering the first mixed signal to generate a first filtered signal, wherein the first filter group comprises a first filter, a second filter, and a third filter, the first filter and the second filter are one-pole filters, and the third filter is a complex-pole filter; and
a first analog-to-digital converter, for performing an analog-to-digital converting operation on the first filtered signal to generate a first digital signal.

2. The communication receiver of claim 1, wherein the second filter is connected between the first filter and the third filter.

3. The communication receiver of claim 1, wherein the third filter is a two-pole filter.

4. The communication receiver of claim 1, wherein a pole quality factor of the third filter is greater than one.

5. The communication receiver of claim 1, wherein the first and second filters are cascaded, and the third filter is a two-order chebyshev filter.

6. The communication receiver of claim 1, wherein the first and second filters have different corner frequencies.

7. The communication receiver of claim 1, wherein the first and second filters are real-pole filters.

8. The communication receiver of claim 1, wherein the first and second filters are active RC filters.

9. The communication receiver of claim 1, wherein a DC offset cancellation circuit is configured in a feedback loop of the second filter instead of the first filter.

10. The communication receiver of claim 1, further comprising:
a second mixer, for mixing the input signal with a second local oscillation signal to generate a second mixed signal, wherein the second local oscillation signal has a quadrature phase difference relative to the first local oscillation signal;
a second filter group, coupled to the second mixer, for filtering the second mixed signal to generate a second filtered signal, wherein the second filter group comprises a fourth filter, a fifth filter, and a sixth filter, the fourth filter and the fifth filter are one-pole filters, and the sixth filter is a complex-pole filter; and
a second analog-to-digital converter, coupled to the second filter group, for performing an analog-to-digital converting operation on the second filtered signal to generate a second digital signal;
wherein the first mixed signal is an in-phase signal and the second mixed signal is a quadrature signal.
